(19) United States
(12) Patent Application Publication
(10) Pub. No.: US 2023/0324088 A1
(43) Pub. Date: Oct. 12, 2023

(54) SORPTION HEAT PUMP AND SORPTION CYCLE

(71) Applicant: AGO GmbH Energie + Anlagen, Kulmbach (DE)

(72) Inventor: Klaus Ramming, Mainleus (DE)

(21) Appl. No.: 18/130,939

(22) Filed: Apr. 5, 2023

(30) Foreign Application Priority Data
Apr. 12, 2022 (EP) 22167876.6

(51) Int. Cl. F25B 15/04; F25B 37/00; F25B 25/02

(52) U.S. Cl. CPC F25B 15/04; F25B 25/02; F25B 37/00

(57) ABSTRACT

A sorption heat pump, comprising a gaseous refrigerant; a liquid solvent; a lean solution and a rich solution, wherein the lean solution and the rich solution are single phase mixes of the liquid solvent and the refrigerant; a first absorber in which the lean solution absorbs a first partial flow of the refrigerant under a pressure drop; a second absorber in which the lean solution absorbs a second partial flow of the refrigerant directly thereafter while respectively dissipating heat; and an expeller in which the rich solution absorbs ambient heat and expels the refrigerant, a down tube arranged between an outlet for the lean solution from the first absorber and an inlet for the lean solution into the second absorber, wherein a hydrostatic pressure of a liquid column of the lean solution in the down tube compensates the pressure drop.

### RELATED APPLICATIONS

This application claims priority from European Patent Application EP 22 167 876.6 filed Apr. 12, 2022, which is incorporated in its entirety by this reference.

### FIELD OF THE INVENTION

The invention relates to a sorption heat pump including a gaseous refrigerant and a liquid solvent. The invention also relates to a sorption cycle including a gaseous refrigerant and a liquid solvent.

The absorption unit including two absorbers in series facilitates using the sorption heat pump with significantly lower temperature differences between the solution and the heating medium, typically water, while simultaneously providing a high spread between inlet temperatures and outlet temperatures of the solution compared to a single absorber.

### BACKGROUND OF THE INVENTION

A generic sorption heat pump with two plate heat exchangers connected as film absorbers and a generic sorption cycle are known from EP 3 964 770 A1. In order to compensate for the pressure drop of the lean solution when flowing through the first absorber the second partial flow of the refrigerant is throttled to the reduced pressure level before entering the second absorber.

Kahn R., An ammonia-water sorption cycle for a high temperature differential, discloses a sorption cycle using a plate heat exchanger as a bubble absorber. The plate heat exchangers configured as drop film or bubble absorbers are described in Niebergall W. Sorption Refrigeration Machines.

### BRIEF SUMMARY OF THE INVENTION

It is an object of the invention to simplify the sorption heat pump.

The object is achieved by a sorption heat pump including a gaseous refrigerant and a liquid solvent, a lean solution and a rich solution, wherein the lean solution and the rich solution are single phase mixes of the solvent and the refrigerant, a first absorber in which the lean solution absorbs a first partial flow of the refrigerant under a pressure drop, and a second absorber in which the lean solution absorbs a second partial flow of the refrigerant immediately thereafter while respectively dissipating heat and an expeller in which the rich solution absorbs ambient heat and expels the refrigerant.

The object is also achieved by a sorption cycle including a gaseous refrigerant and a liquid solvent, a lean solution and a rich solution wherein the lean solution and the rich solution are single phase mixes of the solvent and the refrigerant, and wherein the lean solution absorbs a first partial flow of the refrigerant under a pressure drop and absorbs a second partial flow of the refrigerant immediately thereafter respectively dissipating heat in each step.

The absorption unit including two absorbers in series facilitates using the sorption heat pump with significantly lower temperature differences between the solution and the heating medium, typically water, while simultaneously providing a high spread between inlet temperatures and outlet temperatures of the solution compared to a single absorber.

Improving upon the known sorption heat pump it is proposed according to the invention to provide a down tube between an outlet for the lean solution from the first absorber and an inlet for the rich solution into the second absorber, wherein a hydrostatic pressure of a liquid column of the lean solution in the down tube compensates the pressure drop so that the liquid column of the lean solution at the inlet into the second absorber has a pressure level of the lean solution at an inlet into the first absorber. The hydrostatic pressure of the liquid column compensates the pressure drop without an additional throttle or other additional devices.

Advantageously the first absorber and the second absorber are plate heat exchangers in a sorption heat pump according to the invention. Heat exchangers of this type are simple from an engineering point of view, low maintenance and economically available in a plethora of embodiments.

Advantageously the first absorber and the second absorber are connected as bubble absorber in a sorption heat pump according to the invention. Using plate heat exchangers as bubble absorbers is well known. The lean solution and the refrigerant vapor are then introduced in an equi-directional flow into the absorber from below and both rise up driven by the buoyancy of the bubbles of the refrigerant vapor while they are absorbed by the lean solution. The lean solution that is enriched by the refrigerant vapor exits at an upper end of the absorber.

In the sorption heat pump according to the invention the pressure drop of the solution flowing into the absorber from below and the solution exiting the absorber on top approximately corresponds to the hydrostatic pressure of the liquid column of the lean solution between the two points. The second absorber can thus be arranged adjacent to the first absorber or below the level of the first absorber in order to provide the preceding pressure level at the inlet.

Alternatively, the absorbers can be connected as film absorbers in the sorption heat pump according to the invention like in the sorption heat pump known from EP 3 964 770 A1, wherein the lean solution is introduced on top and the refrigerant vapor is introduced at a bottom so that the lean solution and the refrigerant flow past each other and the enriched lean solution exits at a lower end from the absorber.

Advantageously a sorption heat pump according to the invention includes a throttle valve that reduces the pressure of the rich solution after exiting the second absorber for an entry into the expeller, and a pump that pumps the lean solution into the first absorber after exiting the expeller. A sorption heat pump of this type absorbs heat at a low temperature level and dissipates the heat at a higher temperature level. The rich solution cools in the throttle valve, so that it can absorb the low temperature heat. The gaseous refrigerant and the liquid solvent are separately provided to the absorber. Pumps are well known in refrigeration and economically available in a multitude of embodiments.

Advantageously the sorption heat pump according to the invention includes a compressor that compresses the refrigerant after exiting from the expeller. The sorption heat pump according to the invention then provides in particular heat for buildings.

Alternatively, the sorption machine according to the invention includes a condenser that liquefies the refrigerant after exiting from the expeller, an evaporator that absorbs externally provided heat and evaporates the liquid refrigerant and a refrigerant pump that pumps the liquid refrigerant from the liquefier to the evaporator. The sorption heat pump according to the invention then functions as a heat transformer and provides process heat a low temperature level. Alternatively the sorption machine according to the invention includes a solvent pump that pumps the rich solution into the expeller after exiting from the second absorber, an expansion valve that expands the rich solution after exiting the expeller for entry into the first absorber, a condenser where the refrigerant from the expeller dissipates heat and condenses, an evaporator where the refrigerant absorbs heat before entering into the first absorber and the second absorber, and an expansion valve that expands the liquid refrigerant after exiting the condenser for entering the evaporator. The sorption heat pump according to the invention thus provides cooling.

Advantageously the solvent in the sorption heat pump is water and the refrigerant is ammonia. Water and ammonia are natural substances and well known in the field of refrigeration.

Improving upon the known sorption cycle, it is proposed according to the invention that a hydrostatic pressure of a liquid column of the lean solution compensates the pressure drop and the lean solution absorbs the second partial flow again at the pressure level. This process is performed by a sorption heat pump according to the invention and characterized by its advantages.

Advantageously the partial flows have identical pressure in a sorption cycle according to the invention. In the sorption process according to the invention the partial flows can be divided without throttle or additional equipment.

### EMBODIMENTS

The invention is subsequently described based on advantageous embodiments with reference to drawing figures, wherein:

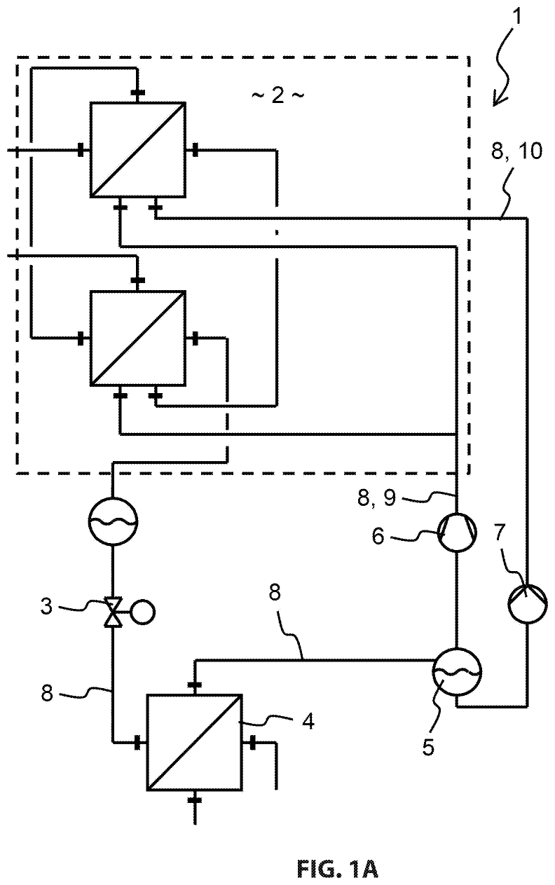

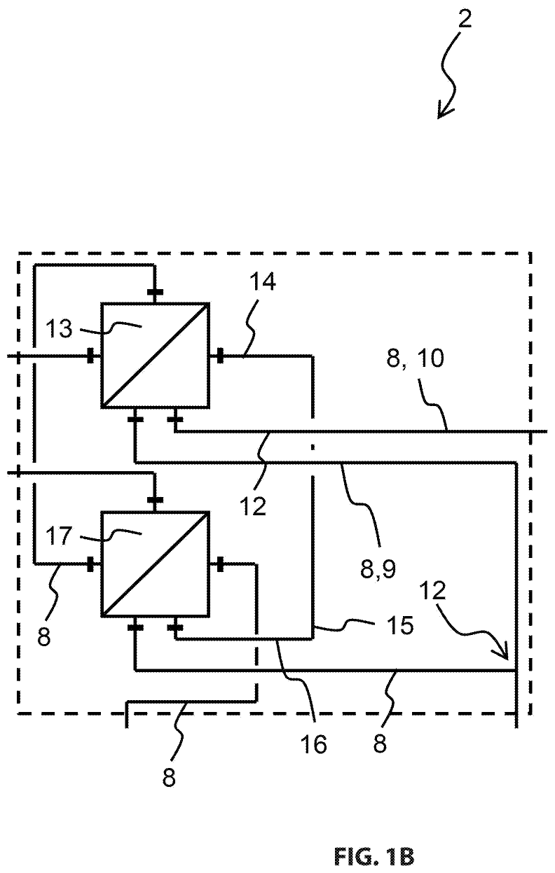

FIG. 1A illustrates a first embodiment of a sorption heat pump according to the invention;

FIG. 1B illustrates a detail of the first sorption heat pump;

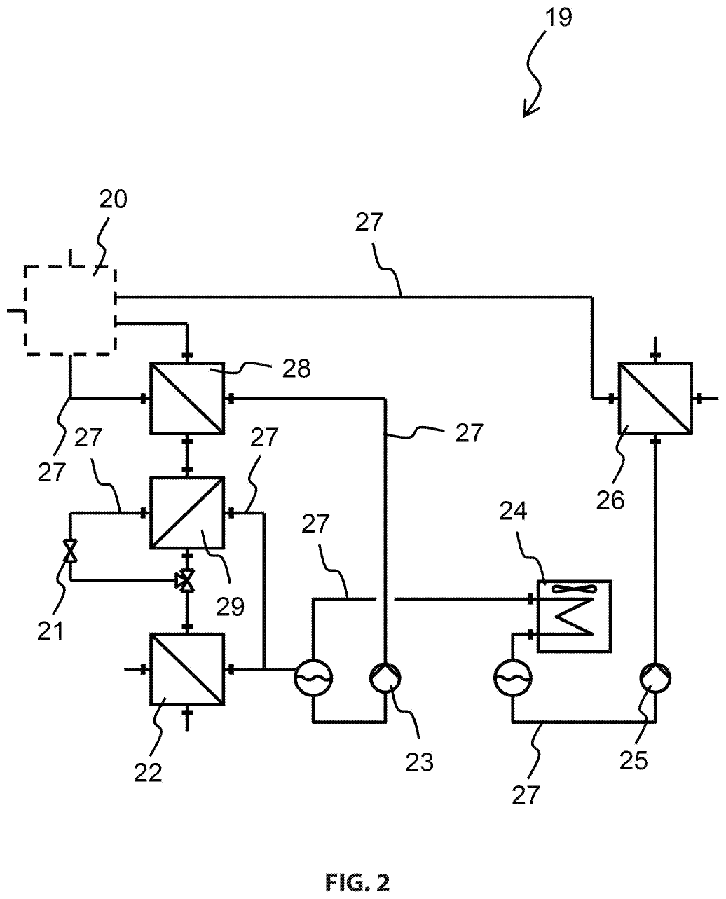

FIG. 2 illustrates a second sorption heat pump according to the invention; and

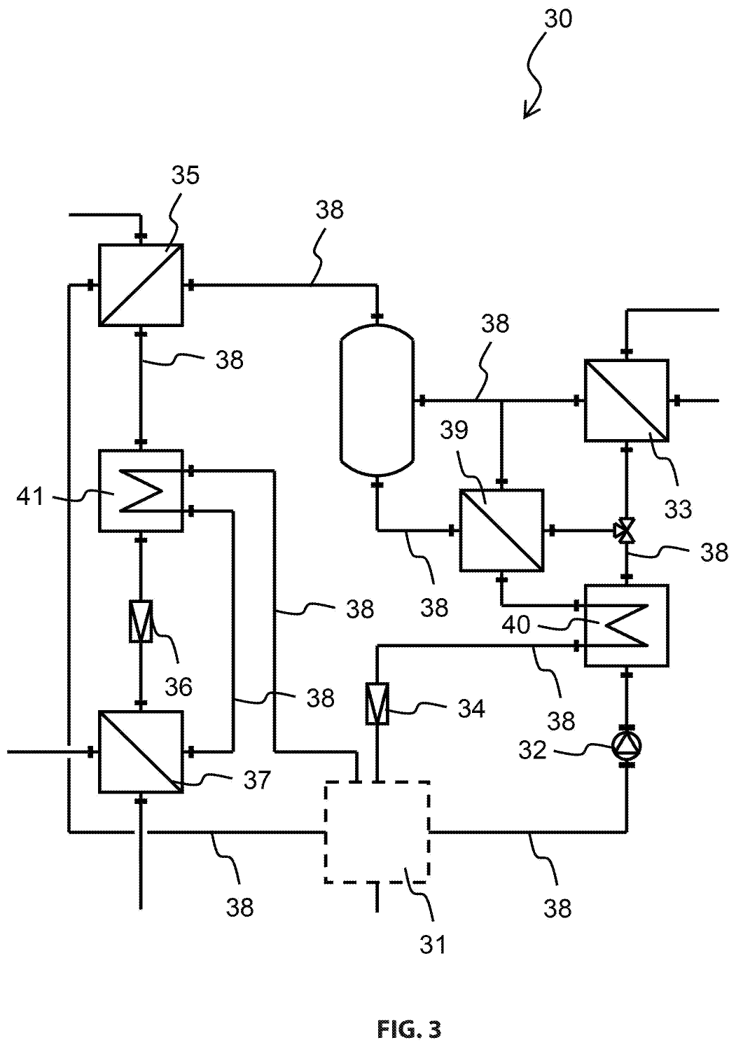

FIG. 3 illustrates a third sorption heat pump according to the invention.

The first sorption heat pump 1 illustrated in FIG. 1 includes an absorption unit 2, a throttle valve 3, an expeller 4, a precipitator 5, a compressor 6, a pump 7 and conduits 8 which connect the elements recited supra in the sequence recited supra to form a closed loop system, wherein the compressor 6 is arranged in a refrigerant branch 9 and the pump 7 is arranged in a parallel solvent branch 10 from the precipitator 5 to the absorption unit 2.

In a sorption cycle according to the invention using ammonia (NH3) as a refrigerant and water as the solvent, a flow of the lean solution absorbs a flow of the refrigerant in the absorption unit 2 and provides heating power to a heating medium. The rich solution exiting the absorption unit 2 at 95° C. at a pressure of 32.9 bar is expanded by the throttle valve 3 to the low pressure of 8 bar and cooled to a temperature of 45° C. and heated in the expeller 4 by a heat source to 88° C. The heat source is thus cooled from 90° C. to 50° C. The lean solution is run by the pump 7 from the subsequent precipitator 5 and the gaseous refrigerant is compressed by the compressor 6 to the high pressure of 33.1 bar and fed into the absorption unit 2.

In the absorption unit 2 shown in FIG. 1B in detail, the refrigerant flow from the compressor 6 is initially divided in a flow divider 11. A first partial flow of the refrigerant is run together with the lean solution through an inlet 12 into a first absorber 13. After absorbing the first partial flow of the refrigerant, a pressure of 32.9 bar is reached at an outlet 14 of the first absorber 13. The solution that is enriched by the refrigerant is run through a down tube 15 and an inlet 16 into a second absorber 17. The enriched solution has the original pressure of 33.1 bar at a bottom of the down tube 15 and at the inlet 16.

The first absorber 13 and the second absorber 17 are plate heat exchangers. The lean solution or the enriched solution and the refrigerant vapor are distributed from below between the plates and rise up and flow upward between the plates wherein the refrigerant vapor is absorbed by the solution. The plates are not illustrated.

A liquid heating medium flows into a top of the second absorber 17 at a temperature of 90° C. and exits a bottom of the first absorber 13 at a temperature of 140° C.

The second sorption pump 19 according to the invention illustrated in FIG. 2 functions as a heat transformer, using ammonia (NH3) as a refrigerant in water as a solvent and absorbs waste heat at a lower temperature level and provides process heat at a higher temperature level. The second sorption heat pump 19 includes an absorption unit 20, a throttle valve 21, an expeller 22, a solvent pump 23, a liquefier 24, a refrigerant pump 25, and an evaporator 26 and conduits 27 that connect the components in the sequence recited supra to form a closed loop system, wherein the solvent is run out of the expeller 22 by the solvent pump 23 and the refrigerant is run in parallel through the liquefier 24, the refrigerant pump 25 and the evaporator 26 into the absorber.

After exiting the absorber, the rich solution initially transfers heat in a solution heat exchanger 28 to the solvent flowing into the absorption unit 20 and subsequently transfers heat in an additional expeller 29 to a partial flow of the rich solution flowing out of the expeller. The absorption unit 20 of the second sorption heat pump 19 corresponds to the absorption unit 2 of the first sorption heat pump 1.

The third sorption heat pump 30 shown in FIG. 3 absorbs heat at a low temperature level operating as a refrigeration machine with ammonia (NH3) as a refrigerant in water as a solvent and dissipates the heat as waste heat to the ambient. The sorption heat pump 30 includes an absorption unit 31, a solution pump 32, an expeller 33, an expansion valve 34, a condenser 35, an expansion valve 36 and an evaporator 37 and conduits 38 which connect the components recited supra in the sequence recited supra to form a closed loop system, wherein the lean solution is run out of the expeller 33 through the expansion valve 34 and the refrigerant is run parallel thereto through the condenser 35, the expansion valve 36 and the evaporator 37 into the absorber.

After exiting from the expeller 33, the rich solution initially transfers heat in an additional expeller 39 to a partial flow of the rich solution run past the expeller 33, and subsequently transfers heat in a solution heat exchanger 40 to the rich solution flowing out of the solution pump 32. The refrigerant vapor flowing out of the evaporator 37 absorbs heat in a cold heat exchanger 41 from the liquid refrigerant between the condenser 35 and the expansion valve 36. The absorption unit 31 of the third sorption heat pump 30 corresponds to the absorption unit 2 of the first sorption heat pump 1.

### REFERENCE NUMERALS AND DESIGNATIONS

1 sorption heat pump
2 absorption unit
3 throttle valve
4 expeller
precipitator
6 compressor
7 pump
8 conduit
9 refrigerant branch
10 solvent branch
11 flow divider
12 inlet
13 first absorber
14 outlet
down tube
16 inlet
17 second absorber
19 sorption heat pump
20 absorption unit
21 throttle valve
22 expeller
23 solvent pump
24 liquefier
25 refrigerant pump
26 evaporator
27 conduit
28 solution heat exchanger
29 expeller
30 sorption heat pump
31 absorption unit
32 solution pump
33 expeller
34 expansion valve
35 condenser
36 expansion valve
37 evaporator
38 conduit
39 expeller
40 solution heat exchanger
41 cold heat exchanger

What is claimed is:

1. A sorption heat pump, comprising:
a refrigerant configured to change between a gaseous state and a liquid state;
a liquid solvent;
a lean solution and a rich solution, wherein the lean solution and the rich solution are single phase mixes of the liquid solvent and the refrigerant;
a first absorber in which the lean solution absorbs a first partial flow of the refrigerant under a pressure drop while dissipating heat;
a second absorber in which the lean solution absorbs a second partial flow of the refrigerant directly after the first absorber while dissipating heat; and
an expeller in which the rich solution absorbs ambient heat and expels the refrigerant;
a down tube arranged between an outlet for the lean solution from the first absorber and an inlet for the lean solution into the second absorber,
wherein a hydrostatic pressure of a liquid column of the lean solution in the down tube compensates the pressure drop so that the liquid column of the lean solution at the inlet into the second absorber has a pressure level of the lean solution at an inlet into the first absorber.

2. The sorption heat pump according to claim 1, wherein the first absorber and the second absorber are plate heat exchangers.

3. The sorption heat pump according to claim 2, wherein the first absorber and the second absorber are connected as bubble absorbers.

4. The sorption heat pump according to claim 1, further comprising:
a throttle valve that expands the rich solution after exiting the second absorber to enter the expeller; and
a pump that pumps the lean solution after exiting the expeller into the first absorber.

5. The sorption heat pump according to claim 1, further comprising: a compressor that compresses the refrigerant after exiting the expeller.

6. The sorption heat pump according to claim 4, further comprising
a liquefier that liquefies the refrigerant after exiting the expeller;
an evaporator that absorbs ambient heat and evaporates liquid refrigerant; and
a refrigerant pump that pumps the liquid refrigerant from the liquefier to the evaporator.

7. The sorption heat pump according to claim 1, further comprising:
a solution pump that pumps the rich solution exiting the second absorber into the expeller;
an expansion valve that expands the lean solution exiting the expeller to enter the first absorber;
a condenser where the refrigerant from the expeller (33) dissipates heat and condenses;
an evaporator where the refrigerant absorbs heat before entering the first absorber and the second absorber; and
an expansion valve that expands the liquid refrigerant exiting the condenser to enter an evaporator.

8. The sorption heat pump according to claim 1, wherein the solvent is water and the refrigerant is ammonia.

9. A sorption cycle, comprising
a refrigerant configured to change between a gaseous state and a liquid state;
a liquid solvent;
a lean solution and a rich solution, wherein the lean solution and the rich solution are single phase mixes of the solvent and the refrigerant,
wherein the lean solution absorbs a first partial flow of the refrigerant under a pressure drop from a pressure level and absorbs a second partial flow of the refrigerant immediately thereafter respectively dissipating heat in each absorption step,
wherein a hydrostatic pressure of a liquid column of the lean solution compensates for the pressure drop and the lean solution absorbs the second partial flow back at the pressure level.

10. The sorption cycle according to claim 9, characterized in that the partial flows have identical pressure.
